(19) United States
(12) Patent Application Publication
(10) Pub. No.: US 2023/0367313 A1
(43) Pub. Date: Nov. 16, 2023

(54) DEVICE AND METHOD FOR CONTROLLING MOVING BODY

(71) Applicant: TOYOTA JIDOSHA KABUSHIKI KAISHA, Toyota-shi (JP)

(72) Inventors: Hiromitsu URANO, Numazu-shi (JP); Sho OTAKI, Yokohama-shi (JP); Masahiro HARADA, Ebina-shi (JP)

(73) Assignee: TOYOTA JIDOSHA KABUSHIKI KAISHA, Toyota-shi (JP)

(21) Appl. No.: 18/186,490

(22) Filed: Mar. 20, 2023

(30) Foreign Application Priority Data
May 16, 2022 (JP) 2022-080430

(51) Int. Cl. G05D 1/00

(52) U.S. Cl. CPC G05D 1/0038; G06V 20/58

(57) ABSTRACT

A device for controlling a moving body on the basis of local operation or remote operation by a remote device, evaluates a degree of change of external conditions during an arbitrary time period from the transmission time when the remote operation information is transmitted from the remote device to the reception time when the moving body receives the remote operation information on the basis of the transmission time information, the reception time information, and the outside recognition information, and if the degree of change is evaluated to fall within an allowable range, allows execution of control of the moving body based on the remote operation information, and if the degree of change is evaluated to not fall within the allowable range, prohibits execution of control of the moving body based on the remote operation information.

### CROSS-REFERENCE TO RELATED APPLICATION

The present application claims priority under 35 U.S.C. § 119 to Japanese Patent Application No. 2022-080430, filed May 16, 2022, the contents of which application are incorporated herein by reference in their entirety.

### BACKGROUND

### Technical Field

The present disclosure relates to a device and method for controlling a moving body on the basis of local operation or remote operation.

### Background Art

Patent Literature 1 discloses a technique of transmitting a remote instruction request from an automatic driving vehicle to a remote instruction device and controlling traveling of the automatic driving vehicle on the basis of a remote instruction transmitted from the remote instruction device. With this technique, whether or not a communication delay occurs between the remote instruction device and the automatic driving vehicle is determined. In a case where it is determined that a communication delay occurs, a remote instruction transmitted in response to a remote instruction request is rejected. This makes it possible to appropriately control traveling of the automatic driving vehicle.

### List of Related Art

Patent Literature 1: JP 2021-33612 A

### SUMMARY

A change of circumstances of an automatic driving vehicle from time at which a remote instruction device transmits a remote instruction to the automatic driving vehicle to time at which the automatic driving vehicle receives the remote instruction will be considered. In this event, in the technique disclosed in Patent Literature 1, even if a change of the circumstances is small, in a case where it is determined that a communication delay occurs, the remote instruction is rejected. This may degrade ride comfort of the automatic driving vehicle as a result of control of the automatic driving vehicle in accordance with the remote instruction becoming intermittent. It is therefore desired to improve the technique to continue control of the automatic driving vehicle based on remote operation information such as a remote instruction even in a case where a communication delay occurs.

One object of the present disclosure is to provide a technique capable of continuously executing control of a moving body based on remote operation information even in a case where a communication delay occurs.

A first aspect is a device for controlling a moving body on the basis of local operation or remote operation by a remote device and has the following features.

The device includes:
one or more processors; and
a storage device configured to store remote operation information received from the remote device, transmission time information when the remote operation information is transmitted from the remote device, reception time information when the moving body receives the remote operation information, and outside recognition information by the moving body, and
the one or more processors perform determination processing of determining whether or not to execute control of the moving body based on the remote operation information, on the basis of the transmission time information, the reception time information, and the outside recognition information during reception of the remote operation information.

In the determination processing,
a degree of change of external conditions during an arbitrary time period from the transmission time when the remote operation information is transmitted from the remote device to the reception time when the moving body receives the remote operation information is evaluated on the basis of the transmission time information, the reception time information, and the outside recognition information, and
if the degree of change is evaluated to fall within an allowable range, execution of control of the moving body based on the remote operation information is allowed, and if the degree of change is evaluated to not fall within the allowable range, execution of control of the moving body based on the remote operation information is prohibited.

A second aspect further has the following features in addition to the first aspect.

In the determination processing, further,
an elapsed time period from the transmission time to the reception time is calculated, and
if the elapsed time period is less than a predetermined time period, the degree of change is evaluated, and if the elapsed time period is equal to or greater than the predetermined time period, execution of control of the moving body based on the remote operation information is prohibited.

A third aspect further has the following features in addition to the first or the second aspect.

In the determination processing,
degrees of change of the external conditions in a tick time period obtained by equally dividing a time period from the transmission time of the remote operation information to the reception time of the remote operation information are evaluated in a chronological order.

A fourth aspect further has the following features in addition to any one of the first to the third aspects.

The outside recognition information includes recognition information of objects around the moving body.

The recognition information of the objects includes at least one of the information on distances from the moving body to the objects, information on relative positions of the objects with respect to the moving body, information on relative speed of the objects with respect to the moving body, and information on a total number of the objects.

In the determination processing,
if the recognition information of the objects is the information on the distances, the degree of change is evaluated on the basis of a difference in distances between start time and end time of the arbitrary time period,
if the recognition information of the objects is the information on the relative positions, the degree of change is evaluated on the basis of a degree of match between relative positions at the start time and relative positions at the end time,
if the recognition information of the objects is the information on the relative speed, the degree of change is evaluated on the basis of a difference between relative speed at the start time and relative speed at the end time, and
if the recognition information of the objects is the information on the total number, the degree of change is evaluated on the basis of a degree of match between a total number at the start time and a total number at the end time.

A fifth aspect further has the following features in addition to any one of the first to the fourth aspects.

The outside recognition information includes recognition information of objects around the moving body.

The storage device further stores identification information of an attention object in the remote operation.

The degree of change of the external conditions is evaluated on the basis of the transmission time information, the reception time information, and recognition information of the attention object.

A sixth aspect further has the following features in addition to any one of the first to the fifth aspects.

The local operation includes basic operation and transition operation of transitioning between the basic operation and the remote operation.

A seventh aspect is a method for controlling a moving body on the basis of local operation or remote operation by a remote device and has the following features.

The method for controlling the moving body includes:
a step of acquiring remote operation information received from the remote device, transmission time information when the remote operation information is transmitted from the remote device, reception time information when the moving body receives the remote operation information, and outside recognition information by the moving body;
a step of performing determination processing of determining whether or not to execute control of the moving body based on the remote operation information, on the basis of the transmission time information, the reception time information, and the outside recognition information during reception of the remote operation information.

The step of performing the determination processing includes:
a step of evaluating a degree of change of external conditions during an arbitrary time period from the transmission time when the remote operation information is transmitted from the remote device to the reception time when the moving body receives the remote operation information on the basis of the transmission time information, the reception time information, and the outside recognition information; and
a step of allowing execution of control of the moving body based on the remote operation information if the degree of change is evaluated to fall within an allowable range and prohibiting execution of control of the moving body based on the remote operation information if the degree of change is evaluated to not fall within the allowable range.

According to the first aspect, the determination processing is performed during reception of the remote operation information. The degree of change of the external conditions during an arbitrary time period from the transmission time when the remote operation information is transmitted from the remote device to the reception time when the moving body receives the remote operation information is evaluated on the basis of the transmission time information, the reception time information, and the outside recognition information. Further, if the degree of change is evaluated to fall within the allowable range, execution of control of the moving body based on the remote operation information is allowed, and if the degree of change is evaluated to not fall within the allowable range, execution of control of the moving body based on the remote operation information is prohibited. In other words, according to the first aspect, the degree of change of the external conditions is evaluated, and in a case where a positive evaluation result is obtained, control of the moving body based on the remote operation information is executed. It is therefore possible to continuously execute control of the moving body based on the remote operation information even in a case where a communication delay occurs.

In a case where an elapsed time period from the transmission time to the reception time is longer than expected, it means that the received remote operation information is old information. It is therefore not appropriate to control the moving body using such old information. Concerning this point, according to the second aspect, execution of the moving body based on the remote operation information is prohibited in a case where the elapsed time period is equal to or greater than the predetermined time period, and the degree of change of the external conditions is evaluated in a case where the elapsed time period is less than the predetermined time period. It is therefore possible to execute control of the moving body on the basis of the remote operation information in a case where the elapsed time period is appropriate.

According to the third aspect, in the determination processing, the degrees of change of the external conditions in the tick time period obtained by equally dividing a time period from the transmission time of the remote operation information to the reception time of the remote operation information are evaluated in a chronological order. By this means, the degrees of change of the external conditions in the tick time period are evaluated during reception of the remote operation information. It is therefore possible to appropriately perform determination processing even in a case where a degree of change of the external conditions in a partial interval (certain tick time period) between the transmission time and the reception time is outside the allowable range.

According to the fourth aspect, the degree of change of the external conditions can be evaluated on the basis of at least one of the information on the distances from the moving body to the objects around the moving body, the information on the relative positions of the objects with respect to the moving body, the information on the relative speed of the objects with respect to the moving body and the information on the total number of the objects.

According to the fifth aspect, in the determination processing, the degree of change of the external conditions is evaluated while the information is narrowed down to the recognition information of the attention object. It is therefore possible to reduce load of the determination processing.

According to the sixth aspect, the local operation includes basic operation and transition operation of transitioning between the basic operation and the remote operation. By this means, in a case where the operation is switched between the local operation and the remote operation, the transition operation is set between the local operation and the remote operation. It is therefore possible to avoid precipitous switching from the local operation to the remote operation or from the remote operation to the local operation, so that it is possible to maintain securing traveling safety of the moving body.

According to the seventh aspect, the same effects as those in the first aspect can be obtained.

### BRIEF DESCRIPTION OF THE DRAWINGS

FIG. 1 is a schematic view of a remote operation system;

FIG. 2 is a conceptual diagram for explaining a communication period between a remote device and a control device;

FIG. 3 is a conceptual diagram for explaining a degree of change of external conditions of a moving body;

FIG. 4 is a view illustrating an example of a result of determination processing of a control device according to a first embodiment;

FIG. 5 is a block diagram illustrating a configuration example of the control device according to the first embodiment;

FIG. 6 is a flowchart illustrating a processing example of an information processing device of the control device according to the first embodiment;

FIG. 7 is a view illustrating an example of evaluation of determination processing of a control device according to a modification of the first embodiment;

FIG. 8 is a flowchart illustrating a processing example of an information processing device of the control device according to the modification of the first embodiment;

FIG. 9 is a flowchart illustrating a processing example of an information processing device of a control device according to a second embodiment;

FIG. 10 is a view illustrating an example of evaluation of determination processing of a control device according to a third embodiment;

FIG. 11 is a view illustrating an example of switching of operation information based on a result of determination processing of a control device according to a fourth embodiment; and

FIG. 12 is a view illustrating an example of switching of operation information based on the result of the determination processing of the control device according to the fourth embodiment.

### DETAILED DESCRIPTION

A device and method for controlling a moving body according to embodiments of the present disclosure will be described with reference to the accompanying drawings. Note that the method for controlling the moving body according to the embodiments is implemented by computer processing of the device that controls the moving body according to the embodiments.

### 1. First Embodiment

### 1-1. Outline

### 1-1-1. Remote Operation System

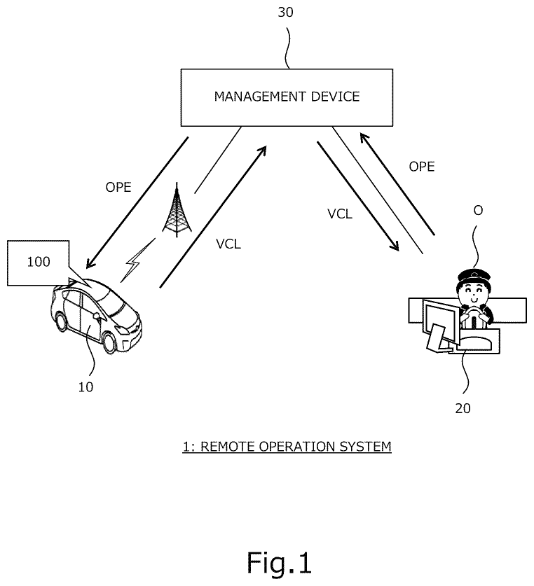

FIG. 1 is a schematic view of a remote operation system. A remote operation system 1 illustrated in FIG. 1 includes a moving body 10, a remote device 20 and a management device 30. A device that controls the moving body according to the embodiment (hereinafter, also simply referred to as a “control device”) 100 is mounted on the moving body 10 and constitutes a part of the remote operation system 1.

Examples of the moving body 10 can include a vehicle, a robot, and the like. Further, examples of the robot can include a logistics robot, a work robot, and the like. The control device 100 includes a traveling actuator. Control of the traveling actuator is performed, for example, on the basis of local operation information. The local operation information is autonomously generated by the control device 100. The local operation information autonomously generated by the control device 100 is also referred to as automatic driving information. The local operation information may be generated by the control device 100 on the basis of manual operation by a driver of the moving body 10.

Control of the traveling actuator may be performed on the basis of remote operation information OPE. The remote operation information OPE is generated by the remote device 20 on the basis of operation input by a remote operator O. The remote operation information OPE includes at least one of the information on remote driving, information on a remote instruction, or information on remote support.

The remote driving is operation of the remote device 20 by the remote operator O at a position away from the moving body 10. Thus, examples of the information on remote driving can include information on an operation amount (such as, for example, a steering angle, acceleration and vehicle speed) generated in accordance with operation input by the remote operator O. Note that the remote driving is performed also in a case where the moving body 10 is traveling by operation by the driver of the moving body 10 as well as in a case where the moving body 10 is autonomously traveling by the control device 100.

The remote instruction is an instruction given by the remote operator O to cause the moving body 10 to travel based on operation by the driver or control for causing the moving body 10 to autonomously travel. For example, when the moving body 10 changes lanes to the fast lane whose road surface state is bad, the remote operator O gives an instruction such as “go straight ahead along the road” to the moving body 10 to prohibit change of lanes. Further, for example, when the moving body 10 cannot recognize lighting color of a traffic light due to backlight, or the like, the remote operator O gives a recognition instruction such as “the lighting color of the traffic light is blue” to the moving body 10. Thus, examples of the information on the remote instruction can include an instruction, and the like (such as, for example, “go straight ahead along the road” and “the lighting color of the traffic light is blue”) to be issued to the moving body 10 by the remote operator O.

The remote support is support of traveling of the moving body 10 based on operation by the driver or control for causing the moving body 10 to autonomously travel. For example, a case will be considered where when the moving body 10 turns right at an intersection with no traffic light, an oncoming vehicle that turns right at the same time is recognized. In this event, in a case where the moving body 10 is autonomously traveling, it is assumed that the moving body 10 cannot autonomously determine whether the own vehicle turns right first or the oncoming vehicle turns right first. Thus, in the remote support, a notification of allowance to start moving, a notification of waiting without starting moving, or the like, by the remote operator O or support of remote driving by the remote operator O is performed. Thus, examples of the information on remote support can include information on a notification (such as, for example, “allowance to start moving” and “waiting without starting moving”) by the remote operator 0, information on an operation amount, and the like.

The remote device 20 is a terminal device to be used by the remote operator O to remotely operate the moving body 10. The remote device 20 can also be referred to as a remote operation human machine interface (HMI).

The management device 30 manages the remote operation system 1. For example, the management device 30 allocates the remote operator O to the moving body 10. Typically, the management device 30 is a management server on cloud. The management server may be constituted with a plurality of servers that perform distributed processing. The moving body 10, the remote operator O and the management device 30 can perform communication with each other via a communication network.

### 1-1-2. Remote Operation

Various kinds of sensors including a camera are mounted on the moving body 10. The camera captures an image of circumstances of the moving body 10 and acquires image information indicating the circumstances of the moving body 10. Moving body information VCL, which is information obtained by various kinds of sensors, includes the image information obtained by the camera. The control device 100 performs communication with the remote device 20 and transmits the moving body information VCL to the remote device 20. The control device 100 may transmit the moving body information VCL to the remote device 20 via the management device 30.

The remote device 20 receives the moving body information VCL transmitted from the control device 100. The remote device 20 presents the moving body information VCL to the remote operator O. Specifically, the remote device 20 includes a display device and displays the image information, and the like, on the display device.

In a case where there is a request for remote operation from the control device 100 or the management device 30, the remote operator O may recognize the circumstances of the moving body 10 by viewing the information displayed on the display device and may remotely operate the moving body 10. Examples of a case where remote operation is requested from the control device 100 can include a case where it is determined to be difficult for the moving body 10 to autonomously travel, and the like. Examples of a case where remote operation is requested from the management device 30 can include a case where it is determined that a problem of traveling safety can arise in a case where the moving body 10 autonomously travels in a road state on a traveling route predicted on the basis of weather information, and the like.

Even in a case where there is no request for remote operation from the control device 100 or the management device 30, the remote operator O may recognize the circumstances of the moving body 10 by viewing the information displayed on the display device and may remotely operate the moving body 10. Examples of a case where the remote operator O remotely operates the moving body 10 include a case where a traveling state (such as, for example, traveling safety) of the moving body 10 is less than a predetermined reference value, and the like.

The remote device 20 performs communication with the control device 100 and transmits the remote operation information OPE to the control device 100. The remote device 20 may transmit the remote operation information OPE to the control device 100 via the management device 30.

The control device 100 receives the remote operation information OPE. The control device 100 controls the traveling actuator of the moving body 10 on the basis of the remote operation information OPE.

### 1-1-3. Determination as to Whether or Not Control of Moving Body Based on Remote Operation Information is Appropriate

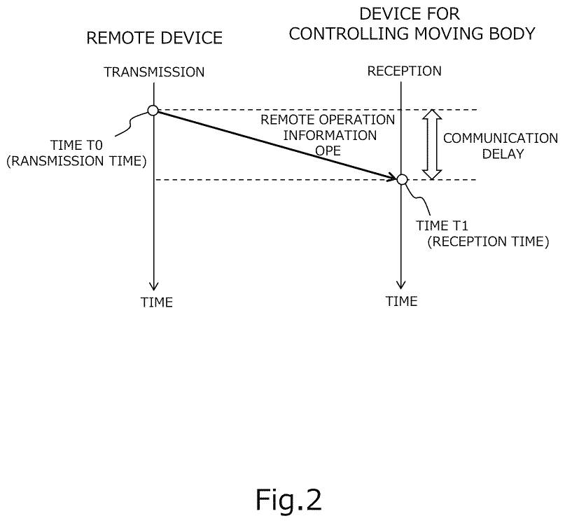

FIG. 2 is a conceptual diagram for explaining a communication period between the remote device 20 and the control device 100. Specifically, transmission time at which the remote operation information OPE is transmitted from the remote device 20 is set as time T0, and reception time at which the control device 100 receives the remote operation information OPE is set as time T1. In this event, there is a time difference between the time T0 and the time T1. In other words, a communication delay occurs in communication between the remote device 20 and the control device 100. It is therefore necessary to consider such a communication delay in control of the traveling actuator based on the remote operation information OPE. Note that the transmission time may be time at which the remote device 20 generates the remote operation information OPE.

In a case where the communication delay is long, it is considered to be inappropriate to control the traveling actuator on the basis of the remote operation information OPE. However, even in a case where the communication delay is long, a case is assumed where there is no object (including a stationary object and a moving object) that can become an obstacle to moving of the moving body 10 around the moving body 10. In such a case, there can be a case where control of the moving body 10 based on the remote operation information OPE does not cause a problem, and interruption of execution of this control would rather lead to another problem. Thus, in the present embodiment, “determination processing” of determining whether or not control of the traveling actuator based on the remote operation information OPE can be executed is performed.

The determination processing includes processing of evaluating a degree of change of the external conditions of the moving body 10 in hours from the time T0 to the time T1. The external conditions are grasped on the basis of outside recognition information by the moving body 10. The outside recognition information includes recognition information of objects around the moving body 10 recognized on the basis of information acquired by sensors (such as a camera and a laser imaging detection and ranging (LiDAR)) mounted on the moving body 10. Examples of the recognition information of the objects can include information on distances from the moving body 10 to the objects, information on relative positions of the objects with respect to the moving body 10, information on relative speed of the objects with respect to the moving body 10 and a total number of the objects existing around the moving body 10. Further, the outside recognition information may include recognition information of color of pixels in camera image information acquired by the camera or may include recognition information of a distance of a point cloud in point cloud information acquired by the LiDAR.

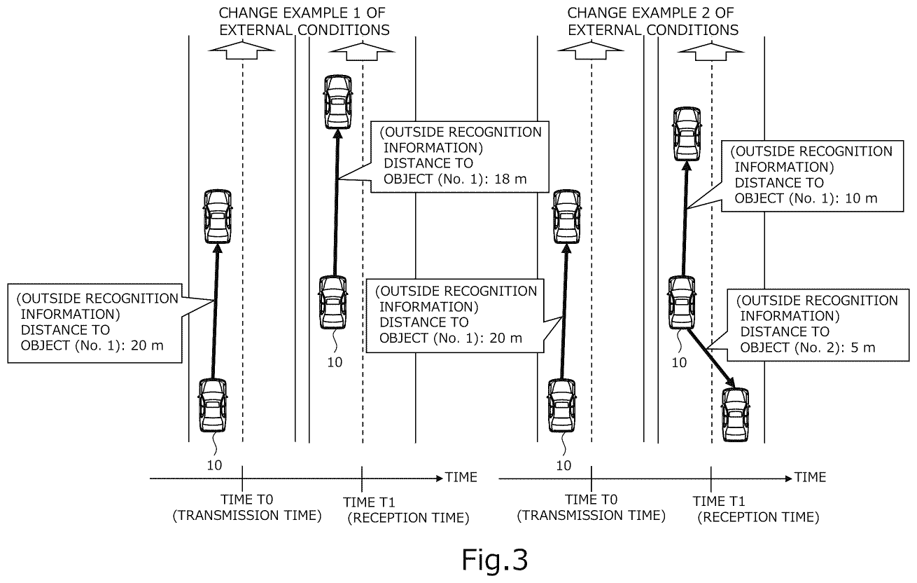

FIG. 3 is a conceptual diagram for explaining a degree of change of the external conditions of the moving body 10. FIG. 3 illustrates an example of a degree of change of the external conditions of the moving body 10 in hours from the time T0 (transmission time) to the time T1 (reception time). Specifically, a left part of FIG. 3 illustrates a degree of change of a distance from the moving body 10 to an object in hours from the time T0 to the time T1. A right part of FIG. 3 illustrates a degree of change of a distance from the moving body 10 to an object in hours from the time T0 to the time T1. Further, the right part of FIG. 3 illustrates a degree of change of a total number of objects existing around the moving body 10 in hours from the time T0 to the time T1. In the example illustrated in the left part of FIG. 3, noticeable degree of change of the external conditions of the moving body 10 in hours from the time T0 to the time T1 cannot be seen, so that it is considered that the degree of change is small. On the other hand, in the example illustrated in the right part of FIG. 3, noticeable degree of change of the external conditions of the moving body 10 in hours from the time T0 to the time T1 can be seen, so that it is considered that the degree of change is large.

In a case where the degree of change is small, it is considered to be appropriate to control the traveling actuator on the basis of the remote operation information OPE. On the other hand, in a case where the degree of change is large, it is considered to be inappropriate to control the traveling actuator on the basis of the remote operation information OPE. Thus, in the determination processing, whether or not the degree of change of the external conditions in hours from the time T0 to the time T1 falls within an allowable range is evaluated. In the determination processing, evaluation may be performed on the basis of recognition information of an object included within a distance that is less than a predetermined distance from the moving body 10. Further, in the determination processing, evaluation may be performed using information on a distance of the object included in the recognition information of the object and a time to collision (TTC) calculated on the basis of the information on the relative speed of the object.

Further, in the determination processing, evaluation may be performed on the basis of past evaluation results. For example, a case will be considered where the remote operation information OPE is transmitted from the remote device 20 in hours during which the degree of change of the external conditions is evaluated as outside the allowable range. In this case, the degree of change of the external conditions in the hours is large, and thus, it may be evaluated that the degree of change of the external conditions is outside the allowable range regardless of the reception time at which the moving body 10 receives the remote operation information OPE.

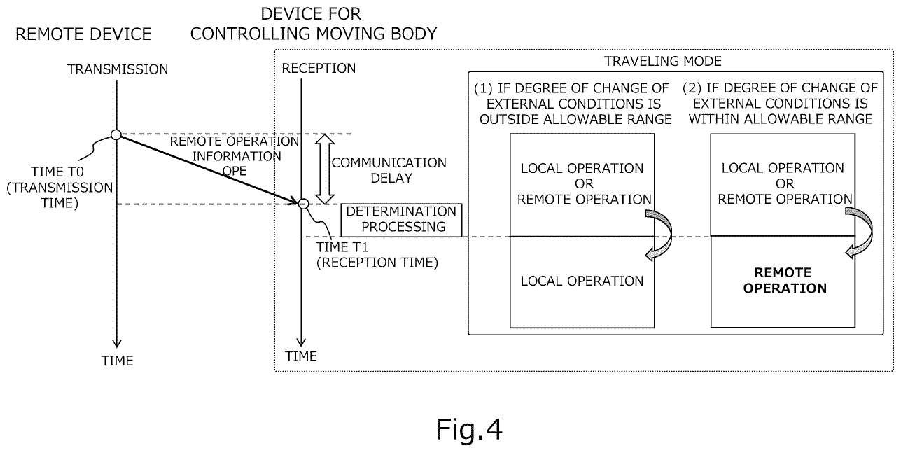

FIG. 4 is a view illustrating an example of a result of the determination processing by the control device 100 according to the first embodiment. In the determination processing described above, in a case where the degree of change of the external conditions is evaluated as within the allowable range, execution of control of the moving body 10 based on the remote operation information OPE is allowed. In a case where execution of control of the moving body 10 based on the remote operation information OPE is allowed, for example, as illustrated in FIG. 4, the remote operation information OPE is selected as a traveling mode. Thus, in a case where execution of control of the moving body 10 is allowed on the basis of the remote operation information OPE, the state is continued, and in a case where execution of control of the moving body 10 is prohibited on the basis of the remote operation information OPE, the state is changed.

On the other hand, in the determination processing described above, in a case where the degree of change of the external conditions is evaluated as outside the allowable range, execution of control of the moving body based on the remote operation information OPE is prohibited. In a case where execution of control of the moving body based on the remote operation information OPE is prohibited, for example, as illustrated in FIG. 4, the local operation information is selected as the traveling mode. Thus, in a case where execution of control of the moving body 10 is allowed on the basis of the local operation information, the state is continued, and in a case where execution of control of the moving body 10 is allowed on the basis of the remote operation information OPE, the state is changed.

The control device 100 according to the first embodiment will be described in further detail below.

### 1-2. Specific Examples

### 1-2-1. Configuration Example

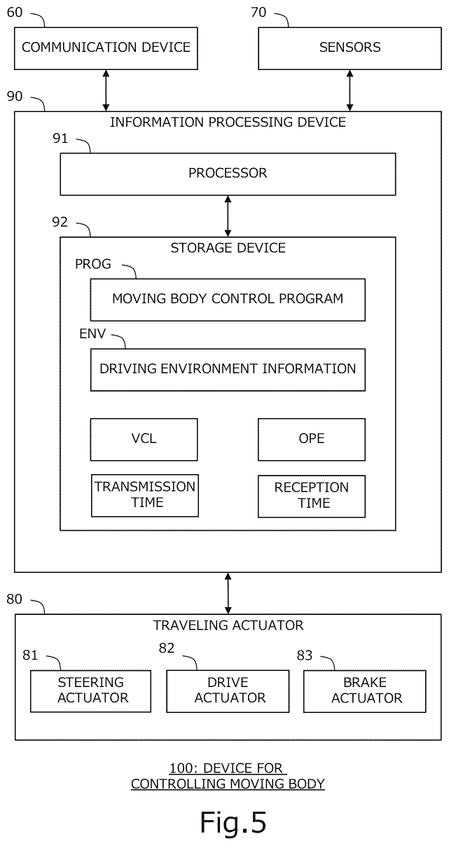

FIG. 5 is a block diagram illustrating a configuration example of the control device 100. The control device 100 includes a communication device 60, sensors 70, a traveling actuator 80 and an information processing device 90.

The communication device 60 performs communication with outside of the moving body 10. For example, the communication device 60 performs communication with the remote device 20 and the management device 30.

The sensors 70 include a recognition sensor, a moving body state sensor, a position sensor, and the like. The recognition sensor recognizes (detects) circumferences of the moving body 10. Examples of the recognition sensor can include a camera, a LiDAR, a radar, and the like. The moving body state sensor detects a state of the moving body 10. The moving body state sensor includes a speed sensor, an acceleration sensor, a yaw rate sensor, a steering angle sensor, and the like. The position sensor detects a position and orientation of the moving body 10. For example, the position sensor includes a global navigation satellite system (GNSS).

The traveling actuator 80 includes a steering actuator 81, a drive actuator 82 and a brake actuator 83. The steering actuator 81 steers tires of the moving body 10. Examples of the steering actuator 81 can include an electric power steering (EPS) actuator. The drive actuator 82 generates drive force. Examples of the drive actuator 82 can include a throttle valve of an engine, a motor, and the like. The brake actuator 83 generates braking force. Examples of the brake actuator 83 can include a motor, a hydraulic brake, and the like.

The information processing device 90 is a computer that controls the moving body 10. The information processing device 90 includes one or more processors 91 (hereinafter, simply referred to as a processor 91) and one or more storage devices 92 (hereinafter, simply referred to as a storage device 92). The processor 91 executes each processing. For example, the processor 91 includes a central processing unit (CPU). The storage device 92 stores various kinds of information necessary for processing by the processor 91. Examples of the storage device 92 can include a volatile memory, a non-volatile memory, a hard disk drive (HDD), a solid state drive (SSD), and the like. The information processing device 90 may include one or more electronic control units (ECU).

A moving body control program PROG is a computer program to be executed by the processor 91. Functions of the information processing device 90 are implemented by the processor 91 executing the moving body control program PROG. The moving body control program PROG is stored in the storage device 92. Alternatively, the moving body control program PROG may be recorded in a computer-readable storage medium.

The information processing device 90 acquire driving environment information ENV indicating a driving environment of the moving body 10 using the sensors 70. The driving environment information ENV is stored in the storage device 92.

The driving environment information ENV includes outside recognition information indicating a recognition result by the recognition sensor. For example, the outside recognition information includes image information captured by the camera. The outside recognition information may include recognition information of color of pixels in the image information and recognition information of a distance of a point cloud in point cloud information acquired by the LiDAR. The outside recognition information may include recognition information of objects regarding the objects (including a stationary object and a moving object) around the moving body 10. Examples of the objects can include a white line, a traffic light, a sign, a roadside structure, a pedestrian, another vehicle (such as a preceding vehicle and a parked vehicle), and the like. The recognition information of the objects includes information on distances from the moving body 10 to the objects, information on relative positions of the objects with respect to the moving body 10, information on relative speed of the objects with respect to the moving body 10, a total number of the objects existing around the moving body 10, and the like.

Further, the driving environment information ENV includes moving body state information indicating a moving body state detected by the moving body state sensor. Further, the driving environment information ENV includes moving body position information indicating a position and orientation of the moving body 10. The moving body position information is obtained by the position sensor. High-precision moving body position information may be acquired by self-position estimation processing (localization) using map information and the outside recognition information.

The information processing device 90 executes moving body traveling control of controlling traveling of the moving body 10. The moving body traveling control includes steering control, driving control, and braking control. The control device 100 executes the moving body traveling control by controlling the traveling actuator 80 (the steering actuator 81, the drive actuator 82 and the brake actuator 83).

The moving body traveling control is applied to local operation and remote operation of controlling traveling of the moving body 10. The local operation includes manual operation, automatic driving control, and the like. The automatic driving control is executed on the basis of the driving environment information ENV.

An example of the automatic driving control is as follows. The control device 100 generates a traveling plan of the moving body 10 on the basis of the driving environment information ENV. Further, the control device 100 generates a target trajectory necessary for the moving body 10 to travel in accordance with the traveling plan on the basis of the driving environment information ENV. The target trajectory includes a target position and target speed. Further, the control device 100 performs moving body traveling control so that the moving body 10 follows the target trajectory.

In the moving body traveling control in the local operation, deviation between a target state corresponding to the traveling plan and a current state of the moving body 10 (such as, for example, position deviation, speed deviation, yaw angle deviation, and acceleration deviation) is calculated. In the moving body traveling control in the local operation, further, a control command value (also referred to as the local operation information) of the traveling actuator 80 of the moving body 10 is calculated so that this deviation decreases. In other words, the control command value is a command value for controlling the current state of the moving body 10 to be a target state. Further, the traveling actuator 80 is controlled on the basis of the control command value.

In the moving body traveling control in the remote operation, the traveling actuator 80 is controlled on the basis of a control command value (also referred to as the remote operation information OPE) of the remote operation included in various kinds of information.

### 1-2-2. Details of Processing Example

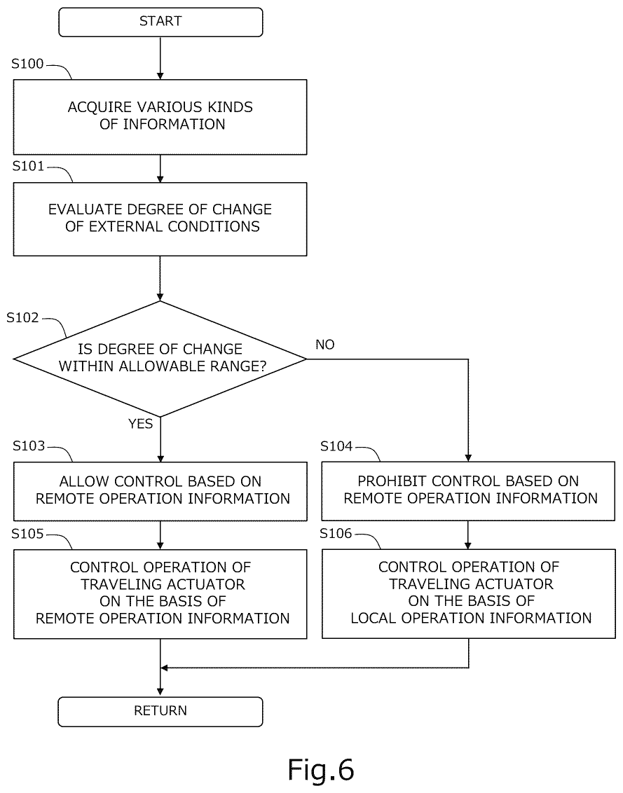

FIG. 6 is a flowchart illustrating a processing example of the information processing device 90. The routine illustrated in FIG. 6 is repeatedly executed with a predetermined time period.

In step S100, the information processing device 90 acquires various kinds of information stored in the storage device 92. Then, the processing proceeds to step S101. Examples of the various kinds of information can include the transmission time information as to transmission time at which the remote operation information OPE is transmitted from the remote device 20, the reception time information as to reception time at which the moving body 10 receives the remote operation information OPE, the driving environment information ENV, information on the traveling route for generating the target trajectory, and the like. The driving environment information ENV includes the outside recognition information, the moving body state information, and the moving body position information. The outside recognition information includes the recognition information of the object, and the like. The recognition information of the object includes at least one of the information on the distances from the moving body to the objects, the information on the relative positions of the objects with respect to the moving body, the information on the relative speed of the objects with respect to the moving body, and the information on a total number of the objects.

In step S101, the information processing device 90 evaluates a degree of change of the external conditions during an arbitrary time period from the transmission time when the remote operation information OPE is transmitted from the remote device 20 to the reception time when the moving body 10 receives the remote operation information OPE on the basis of the transmission time information, the reception time information, and the outside recognition information during reception of the remote operation information OPE. Then, the processing proceeds to step S102.

In step S102, the information processing device 90 evaluates whether or not the degree of change of the external conditions falls within the allowable range. As a specific evaluation example, evaluation is performed as follows. In a case where the recognition information of the objects is the information on the distances, the degree of change is evaluated on the basis of a difference in the distances between start time and end time of the hours. In a case where the recognition information of the objects is the information on the relative positions, the degree of change is evaluated on the basis of a degree of match between the relative positions at the start time and the relative positions at the end time. In a case where the recognition information of the objects is the information on the relative speed, the degree of change is evaluated on the basis of a difference between the relative speed at the start time and the relative speed at the end time. In a case where the recognition information of the objects is the information on the total number, the degree of change is evaluated on the basis of a degree of match between the total number at the start time and the total number at the end time.

In a case where it is determined that the degree of change falls within the allowable range (step S102: Yes), the processing proceeds to step S103. Otherwise (step S102: No), the processing proceeds to step S104.

In step S103, the information processing device 90 allows execution of control based on the remote operation information OPE. Then, the processing proceeds to step S105.

In step S104, the information processing device 90 prohibits execution of control based on the remote operation information OPE. Then, the processing proceeds to step S106.

In step S105, the information processing device 90 controls operation of the traveling actuator 80 on the basis of the remote operation information OPE.

In step S106, the information processing device 90 controls operation of the traveling actuator 80 on the basis of the local operation information.

### 1-3. Effects

In the control device 100 according to the first embodiment, determination processing of determining whether or not to execute control of the moving body based on the remote operation information OPE is performed on the basis of the transmission time information, the reception time information, and the outside recognition information during reception of the remote operation information OPE. In the determination processing, the degree of change of the external conditions in hours from the transmission time to the reception time is evaluated on the basis of the transmission time information, the reception time information, and the outside recognition information. Further, in a case where the degree of change is evaluated as within the allowable range, execution of control of the moving body 10 based on the remote operation information OPE is allowed. On the other hand, in a case where the degree of change is evaluated as outside the allowable range, execution of control of the moving body 10 based on the remote operation information OPE is prohibited. By this means, in a case where the remote operation information OPE by the remote operator 0 is received, the degree of change of the external conditions is evaluated. In a case where the degree of change of the external conditions is evaluated as within the allowable range, execution of control of the moving body 10 based on the remote operation information OPE is allowed, and operation of the traveling actuator 80 based on the remote operation information OPE is controlled. It is therefore possible to continuously execute control of the moving body 10 based on the remote operation information OPE even in a case where a communication delay occurs.

### 1-4. Modifications

In the control device 100 described above, in the determination processing, the degree of change of the external conditions is evaluated on the basis of hours (hereinafter, referred to as a “first interval”) from the transmission time to the reception time. In other words, the degree of change of the external conditions at time between the first intervals is not evaluated. Thus, in the control device 100 according to a modification of the first embodiment, the degree of change of the external conditions is evaluated on the basis of second intervals indicating intervals shorter than the first interval. The second intervals are, for example, tick time period obtained by equally dividing the first interval. In other words, the second intervals are tick time period that can be changed to arbitrary time period, and hours obtained by totaling an aggregate of the second intervals become the first interval. Note that when the first interval cannot be equally divided, the aggregate of the second intervals may include different time period for each second interval.

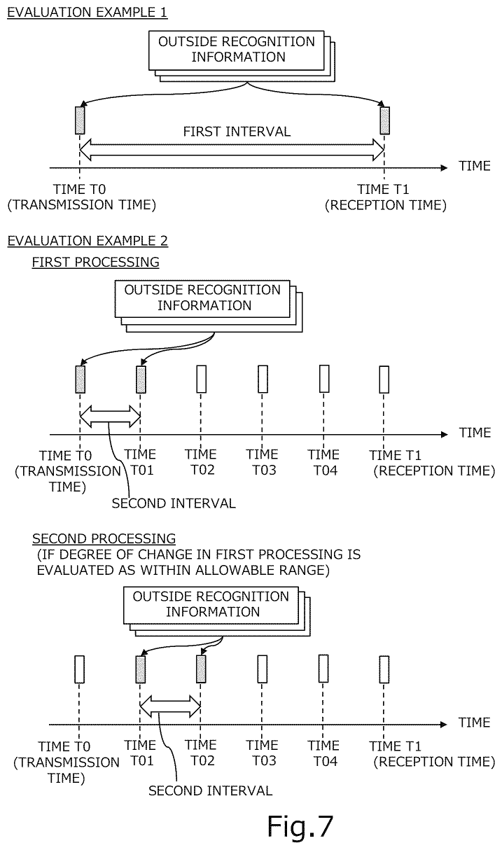

FIG. 7 is a view illustrating an example of evaluation by the control device 100 according to the modification. An upper part of FIG. 7 indicates hours (first interval) to be used for evaluation of the degree of change of the external conditions at the control device 100 described above. Middle and lower parts of FIG. 7 indicate hours (second intervals) to be used for evaluation of the degree of change of the external conditions at the control device 100 according to the modification. For example, as illustrated in FIG. 7, the aggregate of the second intervals is indicated as a second interval between the time T0 and time T01, a second interval between the time T01 and time T02, a second interval between the time T02 and time T03 and a second interval between the time T03 and time T04.

In the control device 100 according to the modification, the degree of change of the external conditions is evaluated in a chronological order from the second interval at the head. Specifically, as illustrated in FIG. 7, whether or not the degree of change of the object information falls within the allowable range in the second interval at the head is evaluated, and in a case where the degree of change is evaluated as within the allowable range, execution of control of the moving body 10 based on the remote operation information OPE is allowed. Then, the degree of change of the external conditions in the next second interval is evaluated. In other words, evaluation of the degree of change of the external conditions is continuously performed until a second interval for which the degree of change of the external conditions is evaluated as outside the allowable range is found among the aggregate of the second intervals from the time T0 to the time T1 illustrated in FIG. 7. Finally, in a case where the degree of change of the external conditions in the last second interval is evaluated as within the allowable range, evaluation of the degree of change of the external conditions in the aggregate of the second intervals (that is, the first interval) from the time T0 to the time T1 is completed.

On the other hand, in a case where the degree of change is evaluated as outside the allowable range, execution of control of the moving body based on the remote operation information OPE is prohibited, and the degree of change of the external conditions in the next second interval is not evaluated.

In a case where new remote operation information OPE is received at and after the time T1, the degree of change of the external conditions in new hours from new transmission time to new reception time is evaluated in a similar manner to the evaluation described above. Note that in a case where the new hour overlaps with the above-described first interval, evaluation may be performed in parallel.

In this manner, in the control device 100 according to the modification, in the determination processing, the degrees of change of the external conditions in the tick time period obtained by equally dividing a time period from the transmission time to the reception time are evaluated in a chronological order. By this means, the degrees of change of the external conditions in the tick time period are evaluated during reception of the remote operation information OPE. It is therefore possible to appropriately perform determination processing even in a case where the degree of change of the external conditions in a partial interval (certain tick time period) between the transmission time and the reception time becomes outside the allowable range.

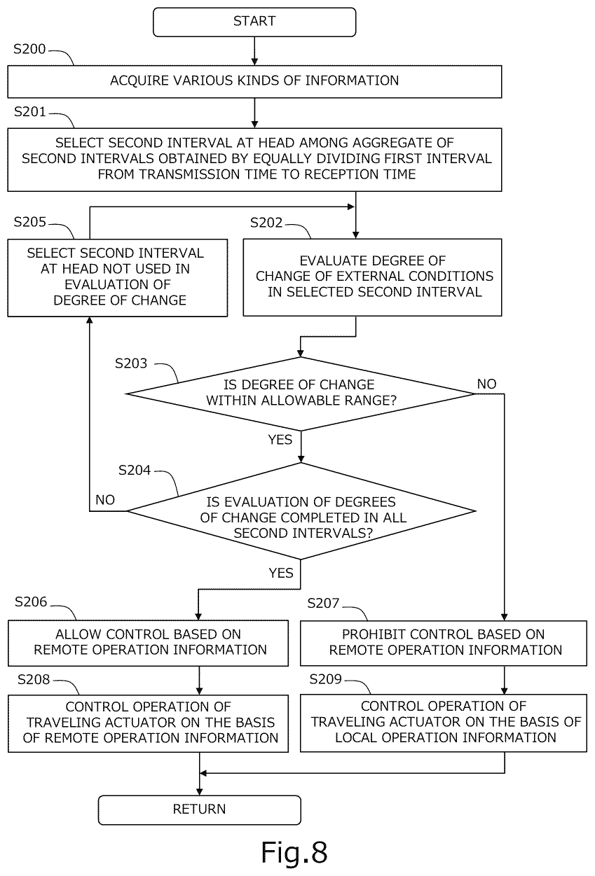

FIG. 8 is a flowchart illustrating a processing example of the information processing device 90 of the control device 100 according to the modification. The routine illustrated in FIG. 8 is repeatedly executed with a predetermined time period.

In step S200, the information processing device 90 acquires various kinds of information stored in the storage device 92. Then, the processing proceeds to step S201. The various kinds of information are the same as the various kinds of information in step S100 described above, and thus, description will be omitted.

In step S201, the information processing device 90 selects the second interval at the head among the aggregate of the second intervals obtained by equally dividing the first interval from the transmission time to the reception time during reception of the remote operation information OPE. Then, the processing proceeds to step S202.

In step S202, the information processing device 90 evaluates the degree of change of the external conditions in the selected second interval on the basis of the transmission time information, the reception time information, and the outside recognition information. Then, the processing proceeds to step S203.

In step S203, the information processing device 90 determines whether or not the degree of change of the external conditions falls within the allowable range. A specific evaluation example is the same as the evaluation example in step S102 described above, and thus, description will be omitted.

In a case where the degree of change of the external conditions is evaluated as within the allowable range (step S203: Yes), the processing proceeds to step S204. Otherwise (step S203: No), the processing proceeds to step S207.

In step S204, the information processing device 90 determines whether or not evaluation of the degree of change is completed in all the second intervals among the aggregate of the second intervals.

In a case where it is determined that evaluation of the degree of change is completed in all the second intervals (step S204: Yes), the processing proceeds to step S206. Otherwise (step S204: No), the processing proceeds to step S205.

In step S205, the information processing device 90 selects the second interval at the head that is not used in evaluation of the degree of change. Then, the processing proceeds to step S202. Note that processing from step S206 to S209 is the same as the processing from step S103 to S106 described above, and thus, description will be omitted.

### 2. Second Embodiment

In the control device 100 according to the first embodiment, even in a case where a communication delay occurs, in a case where the degree of change of the external conditions falls within the allowable range, control of the moving body based on the remote operation information OPE is continued. In a second embodiment, a time period during which a communication delay occurs will be considered. In a case where a time period during which a communication delay occurs is longer than expected, it had better not continue to control the moving body based on the remote operation information OPE. Thus, according to the control device 100 according to the second embodiment, in a case where the communication delay described above is longer than a predetermined time period, control of the moving body based on the remote operation information OPE is prevented from being continued. In other words, “determination processing” of the control device 100 according to the second embodiment includes processing of calculating a time period of a communication delay and processing of evaluating the calculated time period of the communication delay.

By this means, in a case where an elapsed time period from the transmission time to the reception time is longer than expected during reception of the remote operation information OPE, the degree of change of the external conditions is not evaluated. It is therefore possible to prevent control of the moving body based on the remote operation information from being continued even in a case where the elapsed time period is longer than expected.

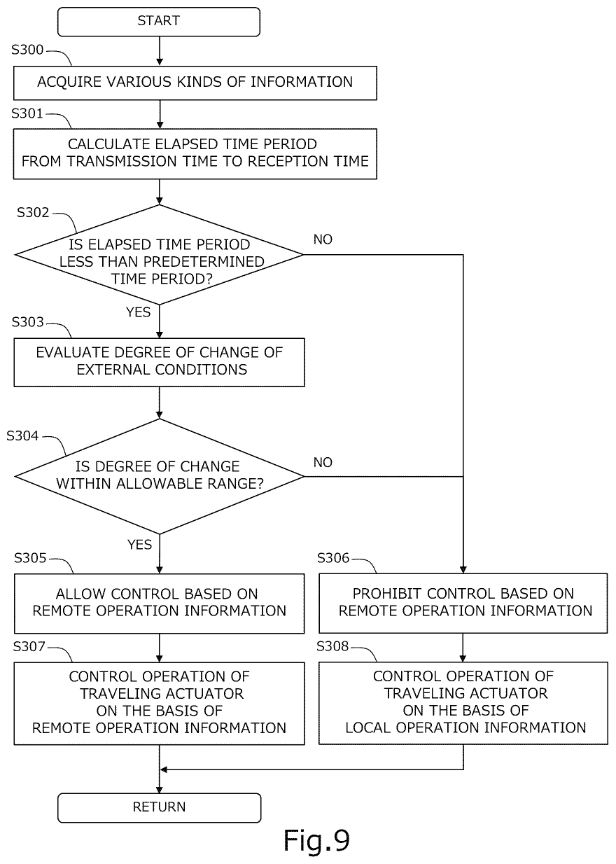

FIG. 9 is a flowchart illustrating a processing example of the information processing device 90 of the control device 100 according to the second embodiment. The routine illustrated in FIG. 9 is repeatedly executed with a predetermined time period.

In step S300, the information processing device 90 acquires various kinds of information stored in the storage device 92. Then, the processing proceeds to step S301. The various kinds of information are the same as the various kinds of information in step S100 described above, and thus, description will be omitted.

In step S301, the information processing device 90 calculates an elapsed time period from the transmission time to the reception time on the basis of the transmission time information and the reception time information. Then, the processing proceeds to step S302.

In step S302, the information processing device 90 determines whether or not the elapsed time period is less than a predetermined time period.

In a case where it is determined that the elapsed time period is less than the predetermined time period (step S302: Yes), the processing proceeds to step S303. Otherwise (step S302: No), the processing proceeds to step S306. Note that processing from step S303 to S308 is the same as the processing from step S101 to S106 described above, and thus, description will be omitted.

### 3. Third Embodiment

In the control device 100 according to the first embodiment, in the determination processing, the degree of change of the external conditions is evaluated without attention being focused on an attention object. According to the control device 100 according to a third embodiment, in the determination processing, the degree of change of the external conditions is evaluated while attention is focused on an attention object. The attention object refers to an object which becomes a factor of determining remote operation.

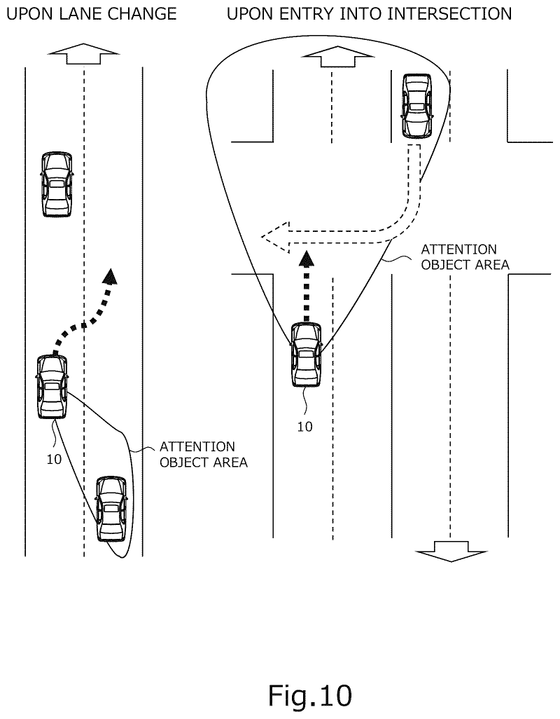

A configuration example of the control device 100 according to the third embodiment will be described. In the storage device 92 in the information processing device 90 included in the control device 100, identification information of an attention object in the remote operation is stored. The identification information of the attention object includes, for example, information on an attention object area indicating an area in which the attention object exists, and the like. Examples of the information on the attention object area can include information on at least one of a left anterior direction, a right anterior direction, an anterior direction (including the left anterior direction and the right anterior direction), a left posterior direction, a right posterior direction, and a posterior direction (including the left posterior direction and the right posterior direction) of the moving body 10, and the like. Specifically, as illustrated in FIG. 10, upon lane change, the right posterior direction of the moving body 10 is indicated as the area in which the attention object exists, and upon entry into an intersection, the anterior direction of the moving body 10 is indicated as the area in which the attention object exists.

In the first embodiment, the recognition information of the objects is used in evaluation of the degree of change of the external conditions in the determination processing. According to the third embodiment, recognition information of the attention object generated on the basis of the recognition information of the objects and the identification information of the attention object is used in evaluation of the degree of change of the external conditions in the determination processing.

In this manner, according to the control device 100 according to the third embodiment, in the determination processing, the degree of change of the external conditions is evaluated while the information is narrowed down to the recognition information of the attention object. It is therefore possible to reduce load of the determination processing.

### 4. Fourth Embodiment

In the control device 100 according to the first embodiment, in a case where the degree of change of the external conditions is evaluated as outside the allowable range, control of the moving body 10 is performed on the basis of the local operation information. Here, switching of the information between the local operation information and the remote operation information OPE will be considered. In a case where control is switched from control of the moving body based on the local operation information to control of the moving body based on the remote operation information OPE, the information is precipitously switched from the local operation information to the remote operation information OPE. In a case where control is switched from control of the moving body based on the remote operation information OPE to control of the moving body based on the local operation information, in a similar manner, the information is precipitously switched from the remote operation information OPE to the local operation information.

Thus, in the control device 100 according to the fourth embodiment, in a case where the operation is switched between the local operation and the remote operation, transition operation of transitioning between the local operation and the remote operation is performed during the local operation. In other words, the local operation information includes basic operation information and transition operation information. Examples of the transition operation information can include operation information for controlling the moving body 10 in consideration of traveling safety such as deceleration traveling and evacuation traveling.

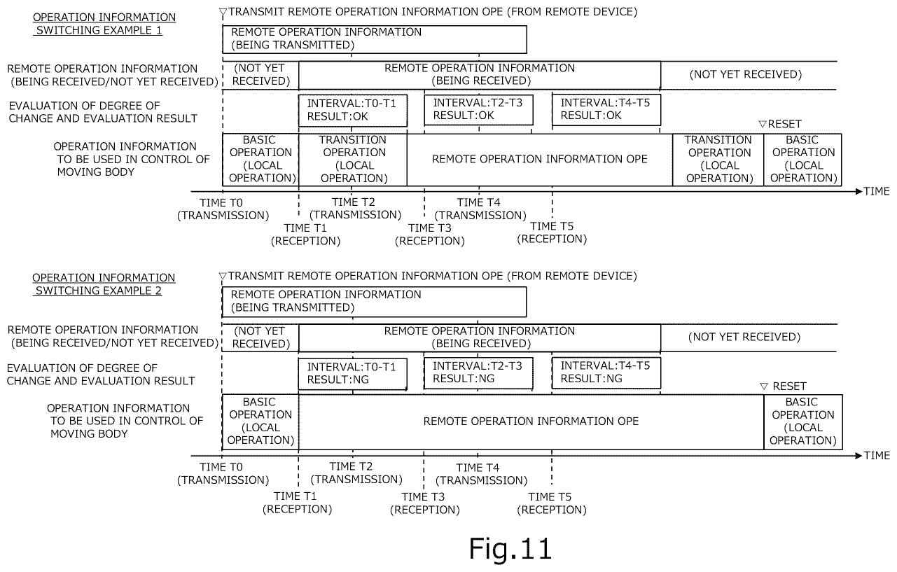

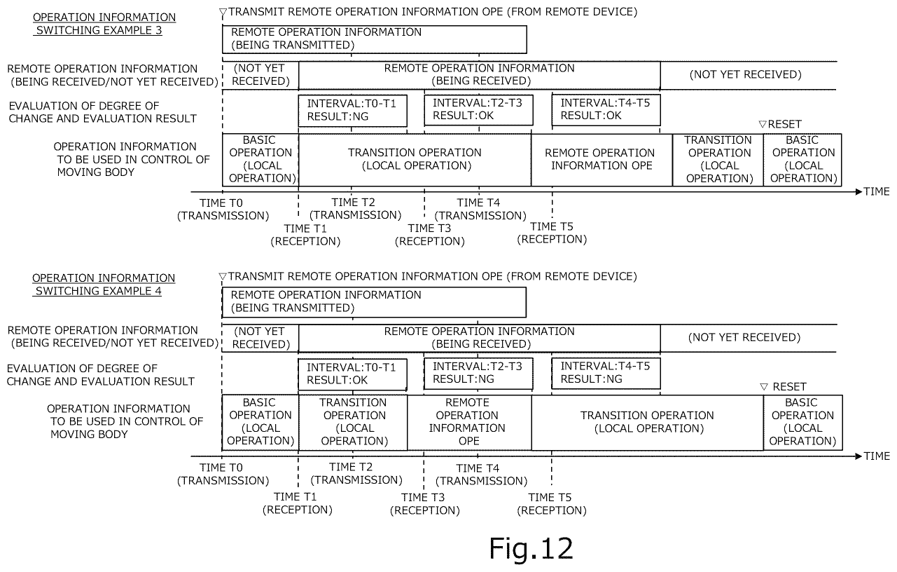

FIG. 11 and FIG. 12 are views illustrating examples of switching of the operation information based on a result of the determination processing by the control device 100 according to the fourth embodiment. An upper part of FIG. 11 is an example of switching of the operation information in a case where the degrees of change of the external conditions in all intervals (the intervals refer to hours from the transmission time to the reception time) are evaluated as within the allowable range during reception of the remote operation information OPE. A lower part of FIG. 11 is an example of switching of the operation information in a case where the degrees of change of the external conditions in all the intervals are evaluated as outside the allowable range during reception of the remote operation information OPE.

In the example illustrated in the upper part of FIG. 11, the basic operation information is set at the control device 100 as the operation information to be used in control of the moving body before reception of the remote operation information OPE. Then, in a case where reception of the remote operation information OPE is started, the information is switched from the basis operation information to the transition operation information, and the transition operation information is set as the operation information to be used in control of the moving body. While the degree of change of the external conditions in a first interval (for example, hours from the time T0 to the time T1 illustrated in FIG. 11) is being evaluated, the transition operation information is continuously set as the operation information to be used in control of the moving body.

Then, in a case where the degree of change of the external conditions in the first interval is evaluated as within the allowable range, the information is switched from the transition operation information to the remote operation information OPE, and the remote operation information OPE is set as the operation information to be used in control of the moving body. In a case where the degrees of change of the external conditions in subsequent intervals (for example, hours from the time T2 to the time T3 illustrated in FIG. 11 and hours from the time T4 to the time T5) are evaluated as within the allowable range, the remote operation information OPE is continuously set as the operation information to be used in control of the moving body.

On the other hand, in the example illustrated in the lower part of FIG. 11, in a case where the degree of change of the external conditions in the first interval (for example, hours from the time T0 to the time T1 illustrated in FIG. 11) is evaluated as outside the allowable range, the transition operation information is continuously set as the operation information to be used in control of the moving body. In a case where the degrees of change of the external conditions in subsequent intervals are also evaluated as outside the allowable range, the transition operation information is continuously set as the operation information to be used in control of the moving body.

An upper part and a lower part of FIG. 12 illustrate examples of switching of the operation information in a case where the degree of change of the external conditions in a certain interval among all the intervals is evaluated as within the allowable range and in a case where the degree of change of the external conditions in another interval is evaluated as outside the allowable range during reception of the remote operation information OPE.

In the example illustrated in the upper part of FIG. 12, in a case where the degree of change of the external conditions in a first interval (for example, hours from the time T0 to the time T1 illustrated in FIG. 12) is evaluated as outside the allowable range, the transition operation information is set as the operation information to be used in control of the moving body. In this state, in a case where the degree of change of the external conditions in the next interval (for example, hours from the time T2 to the time T3 illustrated in FIG. 12) is evaluated as within the allowable range, the information is switched from the transition operation information to the remote operation information OPE, and the remote operation information OPE is set as the operation information to be used in control of the moving body.

On the other hand, in the example illustrated in the lower part of FIG. 12, in a case where the degree of change of the external conditions in the first interval is evaluated as within the allowable range, the remote operation information OPE is set as the operation information to be used in control of the moving body. In this state, in a case where the degree of change of the external conditions in the next interval is evaluated as outside the allowable range, the information is switched from the remote operation information OPE to the transition operation information, and the transition operation information is set as the operation information to be used in control of the moving body.

Note that as illustrated in FIG. 11 and FIG. 12, after the state is switched from a state where the remote operation information OPE is being received to a state where the remote operation information OPE is not yet received, the transition operation information is set as the operation information to be used in control of the moving body, and then, the operation information is reset to the basic operation information. The operation information may be automatically reset to the basic operation information or may be reset through permission by the driver of the moving body 10. Further, in a case where the operation information to be used in control of the moving body is switched from the transition operation information to other operation information or in a case where the operation information is switched from other operation information to the transition operation information, a passenger of the moving body 10 may be notified of the switching.

What is claimed is:

1. A device for controlling a moving body on the basis of local operation or remote operation by a remote device, the device comprising:
one or more processors; and
a storage device configured to store remote operation information received from the remote device, transmission time information when the remote operation information is transmitted from the remote device, reception time information when the moving body receives the remote operation information, and outside recognition information by the moving body,
wherein the one or more processors is configured to:
perform determination processing of determining whether or not to execute control of the moving body based on the remote operation information, on the basis of the transmission time information, the reception time information, and the outside recognition information during reception of the remote operation information,
wherein, in the determination processing,
a degree of change of external conditions during an arbitrary time period from the transmission time when the remote operation information is transmitted from the remote device to the reception time when the moving body receives the remote operation information is evaluated on the basis of the transmission time information, the reception time information, and the outside recognition information; and
if the degree of change is evaluated to fall within an allowable range, execution of control of the moving body based on the remote operation information is allowed, and if the degree of change is evaluated to not fall within the allowable range, execution of control of the moving body based on the remote operation information is prohibited.

2. The device according to claim 1,
wherein, in the determination processing, further,
an elapsed time period from the transmission time to the reception time is calculated; and
if the elapsed time period is less than a predetermined time period, the degree of change is evaluated, and if the elapsed time period is equal to or greater than the predetermined time period, execution of control of the moving body based on the remote operation information is prohibited.

3. The device according to claim 1,
wherein, in the determination processing,
degrees of change of the external conditions in a tick time period obtained by equally dividing a time period from the transmission time of the remote operation information to the reception time of the remote operation information are evaluated in a chronological order.

4. The device according to claim 1, wherein:
the outside recognition information includes recognition information of objects around the moving body;
the recognition information of the objects includes at least one of information on distances from the moving body to the objects, information on relative positions of the objects with respect to the moving body, information on relative speed of the objects with respect to the moving body, and information on a total number of the objects;
if the recognition information of the objects is the information on the distances, the degree of change is evaluated on the basis of a difference in distances between start time and end time of the arbitrary time period;
if the recognition information of the objects is the information on the relative positions, the degree of change is evaluated on the basis of a degree of match between relative positions at the start time and relative positions at the end time;
if the recognition information of the objects is the information on the relative speed, the degree of change is evaluated on the basis of a difference between relative speed at the start time and relative speed at the end time; and
if the recognition information of the objects is the information on the total number, the degree of change is evaluated on the basis of a degree of match between a total number at the start time and a total number at the end time.

5. The device according to claim 1, wherein:
the outside recognition information includes recognition information of objects around the moving body;
the storage device further stores identification information of an attention object in the remote operation; and
the degree of change of the external conditions is evaluated on the basis of the transmission time information, the reception time information, and recognition information of the attention object.

6. The device according to claim 1,
wherein the local operation includes basic operation and transition operation of transitioning between the basic operation and the remote operation.

7. A method for controlling a moving body on the basis of local operation or remote operation by a remote device, the method comprising the steps of:
acquiring remote operation information received from the remote device, transmission time information when the remote operation information is transmitted from the remote device, reception time information when the moving body receives the remote operation information, and outside recognition information by the moving body; and
performing determination processing of determining whether or not to execute control of the moving body based on the remote operation information, on the basis of the transmission time information, the reception time information, and the outside recognition information during reception of the remote operation information,
wherein the determination processing comprising the steps of:
evaluating a degree of change of external conditions during an arbitrary time period from the transmission time when the remote operation information is transmitted from the remote device to the reception time when the moving body receives the remote operation information on the basis of the transmission time information, the reception time information, and the outside recognition information; and
if the degree of change is evaluated to fall within an allowable range, allowing execution of control of the moving body based on the remote operation information, and if the degree of change is evaluated to not fall within the allowable range, prohibiting execution of control of the moving body based on the remote operation information.
